(19) United States
(12) Patent Application Publication
(10) Pub. No.: US 2005/0228845 A1
(43) Pub. Date: Oct. 13, 2005

(54) Shift and recode multiplier

(75) Inventors: Fuk Ho Pius Ng, Plano, TX (US); Liem Thanh Nguyen, Plano, TX (US)

Correspondence Address: WESTMAN CHAMPLIN & KELLY, P.A., SUITE 1600 - INTERNATIONAL CENTRE, 900 SECOND AVENUE SOUTH, MINNEAPOLIS, MN, 55402-3319, US

(73) Assignee: MathStar, Inc., Minneapolis, MN (US)

(21) Appl. No.: 10/822,362

(22) Filed: Apr. 12, 2004

(51) Int. Cl. G06F 7/52

(52) U.S. Cl. 708/627

(57) ABSTRACT

A method and apparatus are provided for multiplying a multiplicand by a multiplier. The method and apparatus generate a plurality of partial products. Each partial product has a plurality of bits having respective binary weights, wherein each bit can have a first or second logic state. A first set of multiple-bit columns is formed from bits of the plurality of partial products, wherein the bits in each column of the first set have the same binary weight. Each multiple-bit column in the first set is encoded into a respective modified partial product, which represents a number of bits in the column having the first logic state. This process can be repeated until the number of partial products is reduces to a desired number.

### FIELD OF THE INVENTION

The present invention relates to semiconductor integrated circuits and more specifically to an arithmetic multiplier.

### BACKGROUND OF THE INVENTION

Semiconductor integrated circuits often include large trees of combination logic gates for performing Boolean and arithmetic functions, such as a multiplication function. In a multiplication function, a binary multiplicand is multiplied by a binary multiplier to produce a binary product. A typical multiplier circuit includes a partial product generator, an adder tree and a final adder. In a typical partial product generator, for each bit of the multiplier, the multiplicand is shifted the appropriate number of bits and multiplied by the value of the digit in that bit of the multiplier to obtain a partial product. The partial products are then added by the adder tree and the final adder to obtain a final product. If the multiplier or the multiplicand has a large number of bits, the partial products addition stage can become very large and complex. Also, the addition of a large number of partial products can be slow.

In addition, as the sizes of transistors on integrated circuits continue to become smaller with new fabrication technologies, the voltage supply levels that drive the transistors are also reduced to prevent damage of the small transistors. This limits the number of transistors that can be connected in series with one another to perform the logical functions in the partial products addition stage, which limits the maximum number of inputs to each logic gate in this stage. The maximum number of inputs is based on the magnitude of the supply voltage and the voltage drop across each transistor in the gate. For example, a given semiconductor technology may limit the number of inputs to a logic AND gate to three bits. This significantly increases the complexity of arithmetic circuits having a large number of input bits since small groups of bits must be combined in multiple logic levels.

The complexity of a logic tree significantly increases with the number of input bits and with more complex logical functions, such as those performed in signed and unsigned binary multiplication. Large logic trees therefore consume large areas on integrated circuits, consume large amounts of power and can have long critical path propagation delays.

Simplified multiplier circuits are therefore desired for performing multiple-bit binary multiplication functions with lower complexity and faster computational speed.

### SUMMARY OF THE INVENTION

One embodiment of the present invention is directed to a method for multiplying a multiplicand by a multiplier. The method includes generating a plurality of partial products, wherein each partial product has a plurality of bits having respective binary weights and wherein each bit can have a first or second logic state. A first set of multiple-bit columns is formed from bits of the plurality of partial products, wherein the bits in each column of the first set have the same binary weight. Each multiple-bit column in the first set is encoded into a respective modified partial product, which represents a number of bits in the column having the first logic state.

Another embodiment of the present invention is directed to a method of adding a plurality of partial products, wherein each partial product has a plurality of bits having respective binary weights and wherein each bit can have a first or second logic state. The method includes forming a first set of multiple-bit columns from bits of the plurality of partial products, wherein the bits in each column of the first set have the same binary weight. Each multiple-bit column in the first set is encoded into a respective modified partial product, which represents a number of bits in the column having the first logic state.

Another embodiment of the present invention is directed to a multiplier circuit having a partial products generator and an adder. The partial products generator has a multiplicand input, a multiplier input and a plurality of partial product outputs. Each partial product output has a plurality of bits having respective binary weights and which can have a first or second logic state. The adder forms a first set of multiple-bit columns from bits of the plurality of partial product outputs, wherein the bits in each column of the first set have the same binary weight. The adder encodes each column in the first set into a respective modified partial product, which represents a number of bits in the column having the first logic state.

### BRIEF DESCRIPTION OF THE DRAWINGS

FIG. 1 is a diagram, which illustrates a typical longhand multiplication algorithm.

FIG. 2 is a diagram, which illustrates an example of a Radix-4 multiplication.

FIG. 3 illustrates grouping of multiplier bits for modified Booth recoding.

FIG. 4 is a block diagram of a shift and recode multiplier according to one embodiment of the present invention.

FIG. 5 is a diagram illustrating a portion of a partial products generator according to one embodiment of the present invention.

FIG. 6 is a block diagram illustrating a typical Wallace Tree.

FIG. 7 is a schematic diagram illustrating reduction of nine partial products and two accumulator terms to four modified partial products, according to one embodiment of the present invention.

FIG. 8 illustrates a second stage reduction, which reduces the number of partial products from four to three, according to one embodiment of the present invention.

FIG. 9 is a diagram illustrating a shifting algorithm according to one embodiment of the present invention.

FIG. 10 is a schematic diagram illustrating a 2-bit shift circuit for shifting 2-bit groups shown in FIG. 9.

FIG. 11 is a schematic diagram illustrating a 3-bit shift circuit for shifting 3-bit groups shown in FIG. 9.

FIG. 12 is a diagram illustrating an overall shifting process in each of three stages, according to one embodiment of the present invention.

### DETAILED DESCRIPTION OF ILLUSTRATIVE EMBODIMENTS

In one embodiment of the present invention, a method and apparatus are provided for multiplying binary words using a Radix-4 modified Booth recoding algorithm in which columns of the partial products are recoded to binary numbers in parallel using shifters. Each bit column of the original binary partial products form a new partial product, which represents the number of logic “1's” in that bit column. This process can be iterated until the number of partial products is reduced to a desired number, which can be added quickly to form the final product. The recoding of each bit column can be performed by packing or shifting all the logic 1's to one end or the other in the bit column and detecting the number of 1's by the logic pattern formed by the packed bit column.

Although embodiments of the present invention are described within the context of a Radix-4 modified Booth recoding algorithm, the recoding and logic reduction functions that are used to add the partial products can be used in any other multiplication algorithm in which multiple partial products are generated. Other Radix values can be used, and Booth recoding is not necessary. Radix-4 multiplication and modified Booth recoding are simply examples of methods that can be used to reduce the number of partial products that are generated.

1. Use of Radix-4 Binary Multiplication

FIG. 1 illustrates a typical longhand multiplication algorithm. In this example, a multiplicand 10 is multiplied by a multiplier 12. For each column in multiplier 12, the multiplicand 10 is shifted by the corresponding number of columns (bit positions) and multiplied by the corresponding bit of multiplier 12 to produce partial products 14. The number of partial products equals the number of bits in multiplier 12. The partial products are then added to one another to produce a product 16. Early digital multipliers were therefore implemented as shift and add circuits. As the length of the numbers being multiplied increases, the number of partial products increase, which increases the number of adders required to add the partial products. A typical multiplier would therefore need a large number of adders.

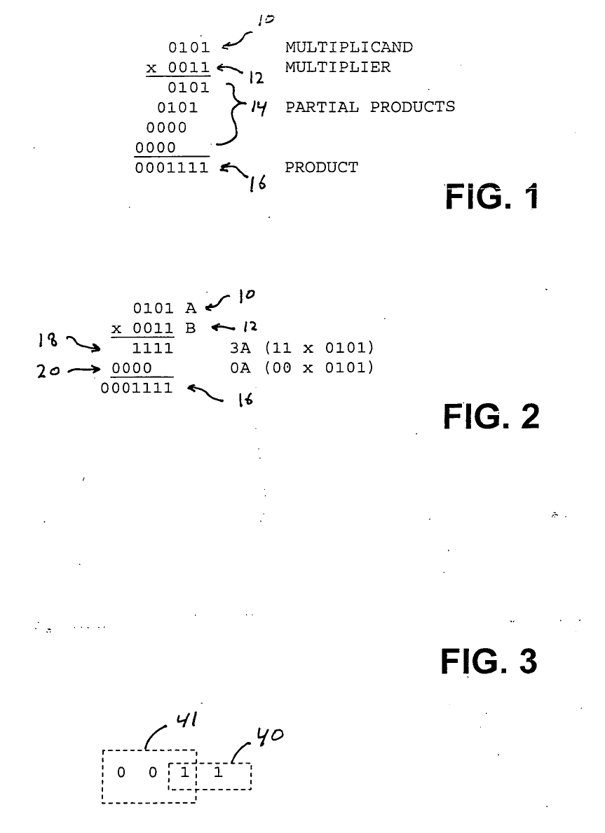

The number of partial products can be reduced by using a higher Radix. FIG. 2 illustrates an example of a Radix-4 multiplication. If “A” represents multiplicand 10 and “B” represents multiplier 12, the values of 2A and 3A are pre-computed. When generating the partial products, multiplier 12 is examined two bits at a time, rather than 1 bit at a time. Based on the values of each 2-bit pair in multiplier 12, a partial product is generated based on 0, A, 2A or 3A, shifted by the correct number of columns in the multiplier. This reduces the number of partial products in half. In the example shown in FIG. 2, the multiplicand (A) is multiplied by the first pair of bits “11” in multiplier 12, producing the partial product “3A”. The multiplicand (A) is then multiplied by the second pair of bits “00” in multiplier 12, producing the partial product “0A”. The partial products 3A and 0A can then be added to produce product 16. In this example, the number of partial products was reduced from four to two.

2. Booth Recoding

Booth recoding is based on the simple observation that a binary “1111” is equal to a binary “10000” minus a binary “1”. Thus if the multiplicand has a string of 1's, such as 1111, four partial products (one for each bit) are not necessary. Long strings of 1's can be skipped by substituting the equivalent value of the multiplicand, such as “10000” and “−1” and then generating only two partial products. This is what is referred to as the Booth Algorithm and has been implemented in software multipliers (multiplier implemented as a software function) and early hardware multipliers, such as the Intel 8087 and 80287 integrated circuit chips.

As series multipliers were replaced by parallel multipliers, the Booth Algorithm was modified to be more efficient. With modified Booth recoding, the multiplier is recoded to eliminate more complex calculations, such as multiplying by three. For example, the multiplier can be recoded to multiply by ±1, ±2 or 0. A multiplication by 3 can be recoded into a multiplication by 4 added to a multiplication by −1 (e.g., 4A+−1A=3A, where 4A is simply A shifted to the left by one bit). This recoding reduces the number and complexity of the partial products since the values of ±1A, ±2A and 0A can be calculated by simple inversion and shifting.

The multiplier is divided into overlapping partial multipliers, wherein the multiplier bits are grouped in blocks of three, as shown in FIG. 3. To Booth-recode multiplier 12, each block of three overlaps the previous block by one bit. The overlap allows the first bit in each block to act as a carry from the previous block.

The grouping starts from the least significant bit. In this example, there are two blocks, labeled 40 and 41. The first bit in block 40 is assumed to be “0” since it is the first block, and the second block 40 has a carry of “1”.

When scanning each group (partial multiplier) from right to left, if the bit pattern changes from 1 to 0, the algorithm adds +A to the partial product. If the bit pattern changes from 0 to 1, the algorithm adds −A to the partial product. This algorithm can then be used to generate a truth table for modified Booth recoding.

Table 1 is a truth table, which identifies the recoding of partial products for each 3-bit overlapping block (BITᵢ₊₁, BITᵢ, BITᵢ₋₁) for modified Booth recoding.

TABLE 1

| | | | | | EQUIV- | CARRY |
|---|---|---|---|---|---|---|
| | | | | | ALENT | TO |
| | | | RECODED | OPER- | FUNC- | NEXT |
| BITᵢ₊₁ | BITᵢ | BITᵢ₋₁ | FACTOR | ATION | TION | BLOCK |
| 0 | 0 | 0 | 0 | +0 | 0 + 0 | 0 |
| 0 | 0 | 1 | 1 | +A | 1 + 0 | 0 |
| 0 | 1 | 0 | 1 | +A | 1 + 0 | 0 |
| 0 | 1 | 1 | 2 | +2A | −2 + 0 | 0 |
| 1 | 0 | 0 | −2 | −2A | −2 + 4 | 1 |
| 1 | 0 | 1 | −1 | −A | −1 + 4 | 1 |
| 1 | 1 | 0 | −1 | −A | −1 + 4 | 1 |
| 1 | 1 | 1 | 0 | −0 | 0 + 4 | 1 |

3. Shift and Recode Multiplier

Even with the use of a higher Radix and modified Booth recoding the number and size of partial products that are generated when multiplying numbers having a greater number of bits can become large. Addition of these partial products can become complex and can consume a large area on the integrated circuit, particularly if the bits can be combined in only small groups. In one embodiment of the present invention, these partial products are added by a shift an recode method, which significantly reduces complexity and speeds computation time.

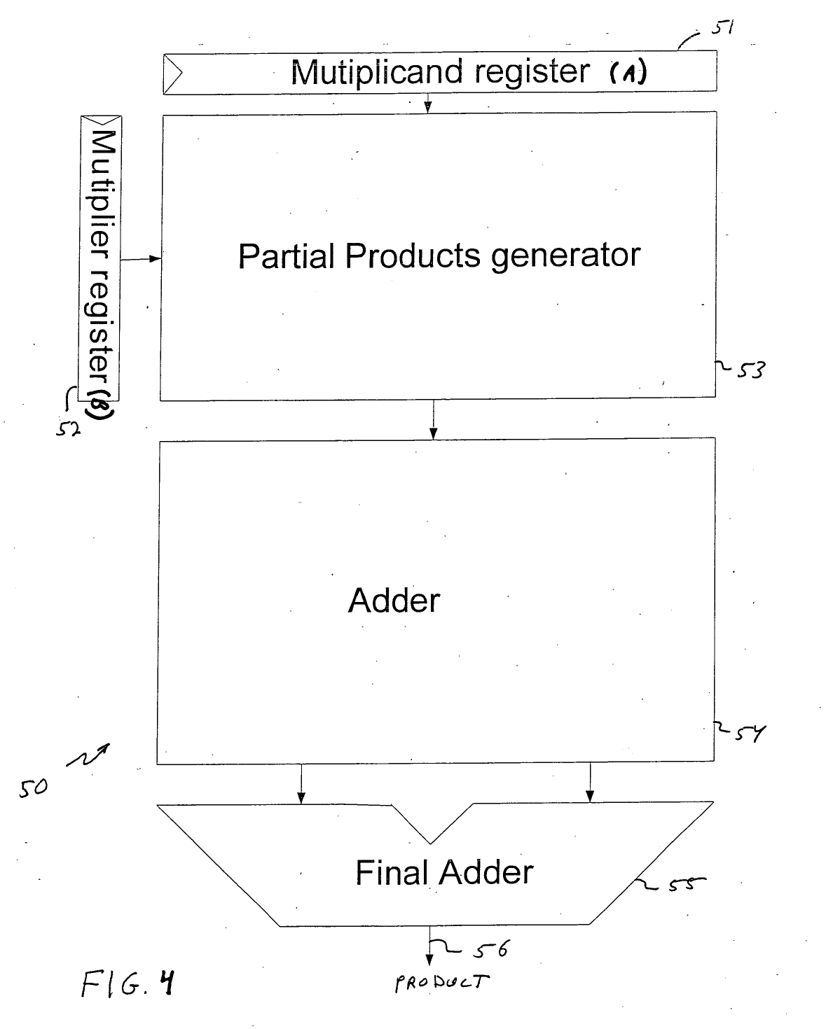

FIG. 4 is a block diagram of a shift and recode multiplier 50 according to one embodiment of the present invention. Multiplier 50 includes a multiplicand register 51 (labeled “A”), a multiplier register 52 (labeled “B”), a partial products generator 53, a partial products adder 54, a final adder 55 and a product output 56 (labeled “PRODUCT”).

Partial products generator 56 receives the multiplicand from register 51 and the multiplier from register 52 and generates a plurality of partial products by multiplying the multiplicand by digits of the multiplier. Partial product adder 58 adds the partial products to generate a pair of carry-sum-like values, which are added together by final adder 60 to produce the product on output 56. In an alternative embodiment, the partial products are reduced to a single product in adder 54 such that final adder 55 is not used.

The partial products can be generated in any suitable manner. The number of partial products is reduced in one embodiment of the present invention by using a Radix-4 modified Booth algorithm. However, any other type of partial product generation algorithm can also be used in accordance with the present invention. For example, other Radix values can be used, and the partial products can be generated by other recoding algorithms or methods similar to traditional longhand multiplication, for example.

With a Radix-4 modified Booth recoding algorithm, the number of partial products is reduced by overlapping 3-bit segments of the multiplier in register 52. The segments of the multiplier are generated by concatenating a “0” on the right (least significant bit) side of the multiplier. The resultant digital word is then divided into 3-bit segments, wherein each segment overlaps its neighboring segment by one bit. For example with a 16-bit multiplier there will be eight segments, identified by bits 1:0, 3:1, 5:3, 7:5, 9:7, 11:9, 13:11, and 15:13. Each of these segments is then used to generate a partial product according to Table 1. For example, if a 3-bit segment is “011”, the partial product will be two times the multiplicand (2A), which is simply the multiplicand shifted left by one bit.

As described above, these partial products can be pre-computed. For example, if the following binary values:
A=0001 1001 0110 0000 (Multiplicand)
B=0000 1001 0001 1100 (Multiplier)
   are used for the multiplicand and the multiplier, then following possible partial products can be pre-computed:
+A=00001100101100000
+2A=00011001011000000
−2A=11100110101000000
−A=11110011010100000

Given these pre-computed values, the partial product generator can easily generate the actual partial products by selecting from the pre-computed values based on the 3-bit overlapping segments of the multiplier.

In the above-example, the segments are, 000 (including the concatenated “0”), 110, 011, 000, 010, 100, 001 and 000.

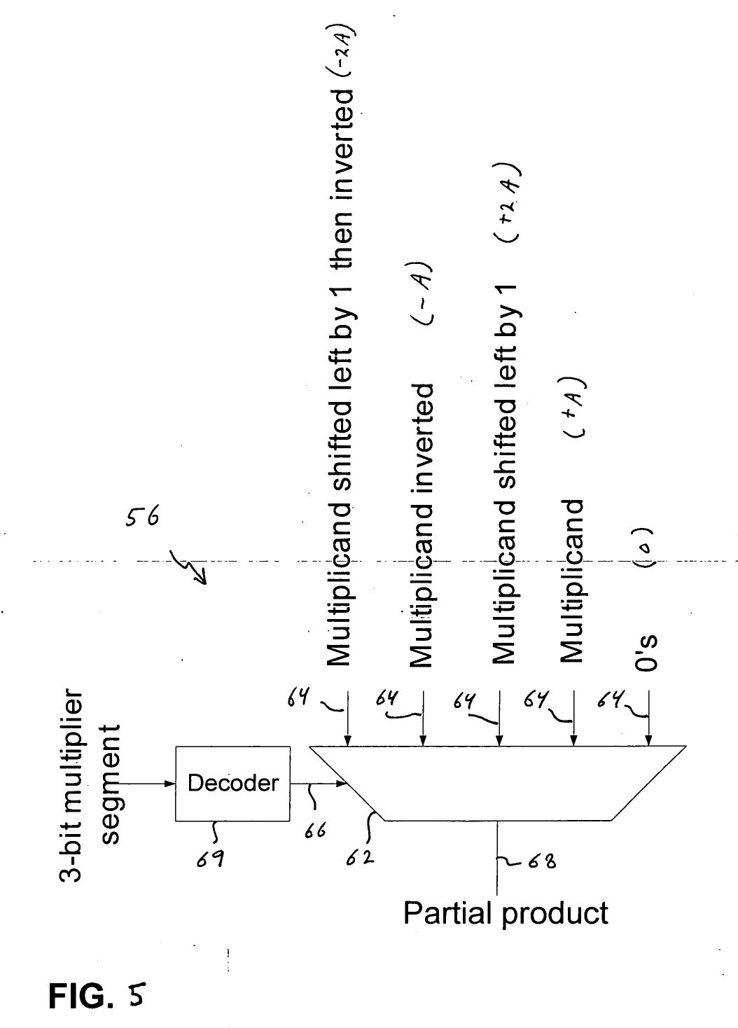

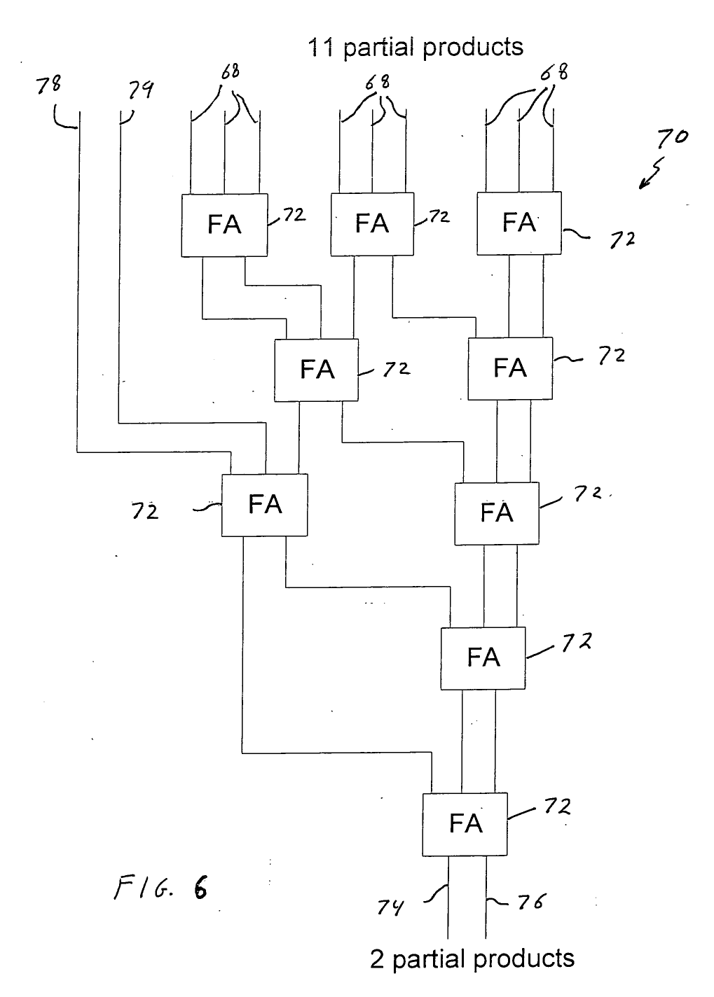

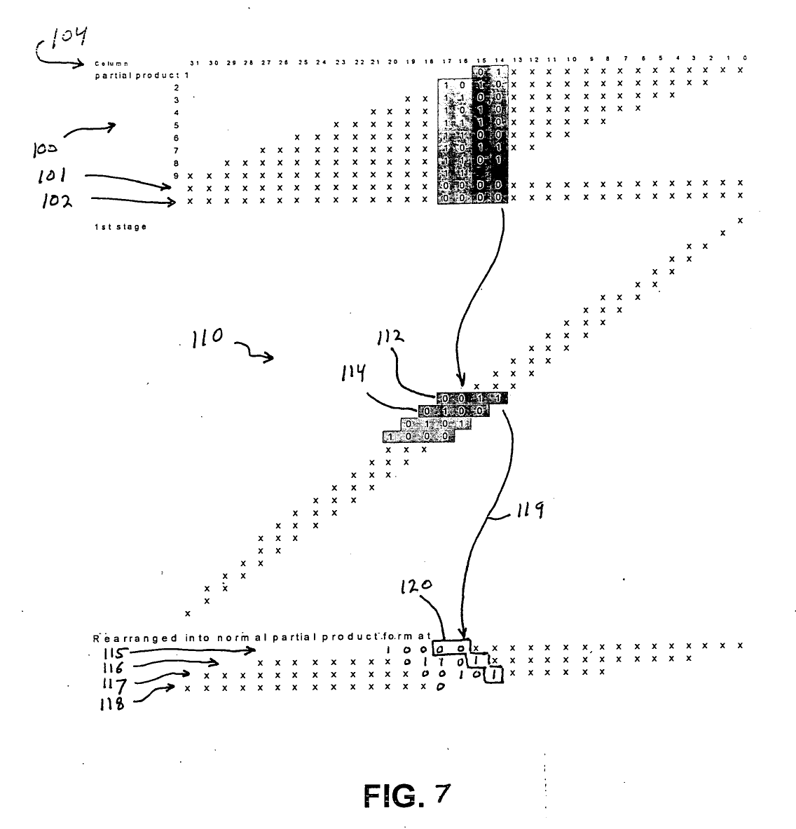

FIG. 5 is a diagram illustrating a portion of partial products generator 53 according to one embodiment of the present invention. Partial products generator 53 includes a plurality of multiplexers 62, one multiplexer 62 for each 3-bit segment of multiplier B, which are driven in parallel by the pre-computed partial product values. Each multiplexer 62 includes a plurality of multiplexer data inputs 64, which are coupled to respective ones of the pre-computed partial product values (e.g., 0, +A, +2A, −A, and −2A). Each multiplexer 62 has a select input 66, which is decoded from the respective 3-bit multiplier segment by decoder 69.

The value of the 3-bit multiplier segment determines which of the pre-computed partial products is coupled to multiplexer output 68. The resulting partial products 68 are shifted to the left by an appropriate number of bits, which is determined by the binary weight of the 3-bit multiplier segment on the multiplier. In the case of a 16-bit multiplier, nine partial products will be produced.

Because of the 3-bit overlapping segmentation of the multiplier, partial products 68 are shifted by two additional bits for each successive segment. A “1” is added to the least significant bit of the partial product when an inverted multiplexer input (−A or −2A) is selected. Additional bits are added conditionally at the most significant bit end of the partial products to take care of sign extension.

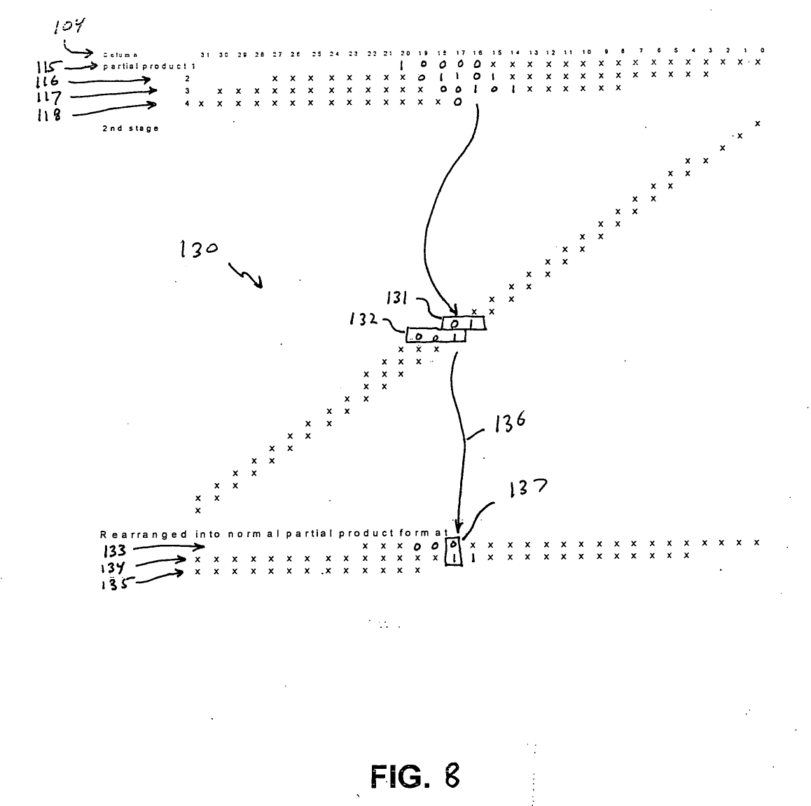

Traditionally, the resulting partial products are added together with a full adder tree, such as a Wallace Tree, to reduce the number of partial products down from nine to two. FIG. 6 is a block diagram illustrating a typical Wallace Tree 70. Wallace Tree 70 includes a plurality of full adders 72. Each full adder 72 receives three inputs and produces two outputs. With nine partial products, it will take four layers of full adders 72 to reduce to two partial products 74 and 76.

For multiply and accumulate operations, two additional sum and carry terms, 78 and 79, can be supplied by an accumulator for adding to the partial products 68. An accumulator allows multiply-accumulate operations to be done without having to wait for the final adder. This adds a further layer to tree 70. A final adder can be used to produce the final product from outputs 74 and 76.

In contrast to the full adder approach shown in FIG. 6, partial products adder 54 (shown in FIG. 4) combines the partial products according to a shift and recode algorithm. Instead of treating partial products as numbers and adding them horizontally, the partial products are added vertically.

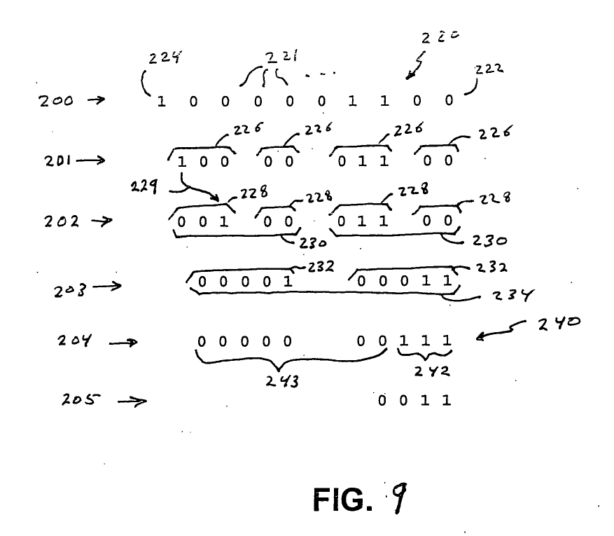

FIG. 7 is a schematic diagram illustrating the reduction of nine partial products and two accumulator terms to four modified partial products through a first reduction stage, according to one embodiment of the present invention. The nine partial products, labeled “partial product 1” to “partial product 9”, are arranged in rows indicated by arrows 100. Each partial product is shifted horizontally to the left to represent the relative binary weight of that partial product. Rows 101 and 102 represent sum and carry terms received from a multiply-accumulate register (not shown).

The “x's” in rows 100, 101 and 102 represent binary digits in the multiplication process, wherein each “x” can be either a “1” or a “0” depending on the values of the multiplicand and the multiplier. Rows 100, 101 and 102 are aligned horizontally such that the digits in each column 104 have the same binary weight.

In one embodiment of the present invention, each bit column of partial products 100-102 is recoded to a binary number representing a count of the 1's in the corresponding column. Each of these binary numbers becomes a new partial product 110.

For example bit column 14 forms a binary word “1000001100” having three binary symbols with the value “1”. As described in more detail below, the number of binary 1's in each column are counted in parallel using shifters, for example. The count of three is converted to a binary value “0011”, which becomes one of the partial products 110, represented by arrow 112.

Bit column 15 has four 1's, therefore modified partial product 114 has the binary value “0100”. Each of the modified partial products 110 is arranged in FIG. 7 according to its binary weight, such that bits in the same column in FIG. 7 have the same binary weight. As can be seen in FIG. 7, the maximum number of bits in any column of modified partial products 110 is now four. Thus, the first stage of recoding has reduced the number of partial products from eleven to four.

Modified partial products 110 can be visually rearranged to form four partial products 115-118, by simply “dropping” the bits in each column as shown by arrow 119. For example, the bits in modified partial product 112 are shown by box 120. The bits can be rearranged in a variety of other manners in alternative embodiments of the present invention.

The process of shifting and recoding is then iterated until the number of partial products is reduced to a desired number, such as two. For a 16 bit multiplier, this will take three stages in one embodiment of the present invention.

FIG. 8 illustrates a second stage of the shifting and recoding process, which reduces the number of partial products from four to three. Again, row 104 identifies each column of the modified partial products 115-118, which are labeled “partial product 1” to “partial product 4”. The number of 1's in each column 104 of the modified partial products 115-118 is recoded into a binary value, and these binary values form further modified partial products 130.

For example, column 16 has three bits “001” with one binary “1”, which are recoded into the binary value “01” to form a further modified partial product 131. Column 17 has four bits “0100” with one binary “1”, which are recoded into the binary value “001” to form a further modified partial product 132. The maximum number of bits in any column of the further modified partial products 130 is now three. The bits in each column can then be visually rearranged to form three partial products 133, 134 and 135. For example, the bits of partial products 130 in column 16 are “dropped” along arrow 136, as can be seen by box 137.

The three further modified partial products 133, 134 and 135 can then be shifted and recoded in a similar fashion to form two partial products. Then, a final adder, such as adder 60 shown in FIG. 4, can be used to add the final two partial products to produce the product. Alternatively, a further reduction stage can be used to reduce the two partial products to a single product.

Other implementations can also be used. For example, instead of using three stages (reductions from 11-to-4, 4-to-3, and 3-to-2), two 4-to-3 stages can be used in parallel, followed by a 6-to-3 stage and then a 3-to-2 stage. Also, one or more of these stages can be mixed with traditional full adder cells, since a full adder cell is fairly efficient in a 3-to-2 conversion.

4. Counting the Number of 1's in Each Bit Column

Any method can be used to count the number of “1's” in each bit column of a plurality of partial products. In one embodiment of the present invention the number of 1's is counted by shifting or “packing” the 1's in each column to one end of the column or the other and then detecting the bit position of the left-most (or right-most) “1”. This bit position represents the number of 1's in the binary word formed by each bit column of the partial products.

A variety of methods can be used to shift the bits in each column. FIG. 9 is a diagram illustrating a shifting algorithm according to one embodiment of the present invention. Row 200 represents the 10-bit binary word formed by column 14 of the initial partial products 100-102 in FIG. 7. Each row in FIG. 9 represents a successive step in packing the bits toward one end or the other and encoding the number of 1's into a binary value. In row 200, the binary word has a plurality of bit positions 221 between right end 222 and left end 224.

At step 201, word 220 is divided into groups of adjacent bits to form a first level of multiple-bit groups 226. In this example, each of the groups 226 includes two or three bits. The number of bits in each group can be set based convenience and on a maximum number of transistors that can be connected in series with one another in the technology in which the integrated circuit will be fabricated. Each group 226 can include any number of bits in alternative embodiments of the present invention.

For each group 226 in row 201, a packing circuit packs all of the 1's toward the right end, for example, of that group. This forms a modified first level group 228, shown in row 202, for each of the first level groups 226. For example, the left-most group 226 has a logic pattern “100”. Arrow 229 illustrates the shifting or packing of a “1” in the third bit position of group 226 to the first bit position in group 228.

Row 203 represents the output of a second logic level in the packing circuit. The packing circuit groups adjacent to pairs of modified first level groups 228 into larger second-level groups 230. Each second level group 230 has 5-bits. Again, for each second level group 230, the packing circuit packs any of the bits in that group having a logic “1” state toward the right end of that group, and all bits having a logic “0” toward the left end of that group to form a modified second level group 232 in row 203.

The packing circuit groups adjacent to pairs of the modified second-level groups 232 into a larger third-level group 234. Row 204 represents the output from the third-level of logic in the packing circuit. Again, all bits having a “1” state are packed toward the right side of group 234.

After the packing operation is complete, bit column word 240 includes a first set 242 of contiguous bit positions having a logic high state, and a second set 243 of bit positions having a logic low state. With all of the logic high states packed to the right, the number of logic high states can be easily detected by detecting the bit position of the left-most “1” in modified data word 240 by an appropriate encoding circuit. In this example, modified data word 240 has three 1's, which is encoded into a binary “0011”, as shown by row 205. This binary value then forms one of the modified partial products, such as modified partial product 112 shown in FIG. 7.

The process shown in FIG. 9 repeats for each stage of the reduction process described with reference to FIGS. 7 and 8, although the number of bits to pack reduces at each stage.

The remaining figures illustrate examples of circuits that can be used by the packing circuit to shift the 1's in each partial product bit column and encode its result into a binary word to form a modified partial product.

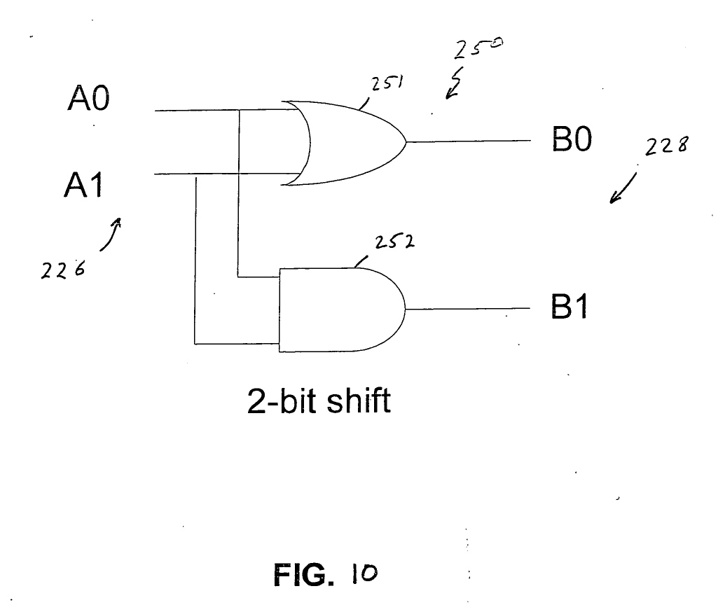

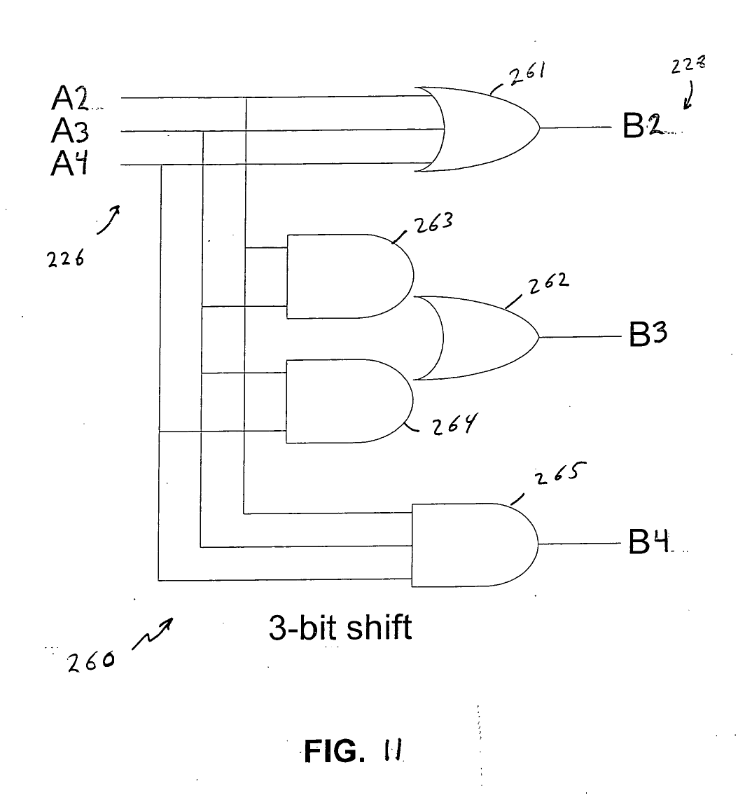

FIG. 10 is a schematic diagram illustrating a 2-bit shift circuit 250 for shifting each 2-bit group 226 shown in row 201 of FIG. 9. Circuit 250 includes a logic OR gate 251 and a logic AND gate 252. Inputs A0 and A1 represent the two inputs bits, and Y0 and Y1 represent the two output bits. A similar 2-bit shift circuit is used to shift each 2-bit group 226.

FIG. 11 is a schematic diagram illustrating a 3-bit shift circuit 260 for shifting the bits in each 3-bit group 226 in row 201 of FIG. 9. Circuit 260 includes logic OR gates 261 and 262 and logic AND gates 263, 264 and 265. Inputs A0, A1, and A2 represent the least significant, middle, and most significant bit positions in a corresponding 3-bit group 226. Outputs Y0, Y1 and Y2 represent the least significant, middle and most significant bit positions, respectively, in the respective modified 3-bit group 228. In one embodiment, the packing circuit includes one 3-bit shift circuit 260 for each 3-bit group 226. Again, any combination of logic can be used in alternative embodiments of the present invention.

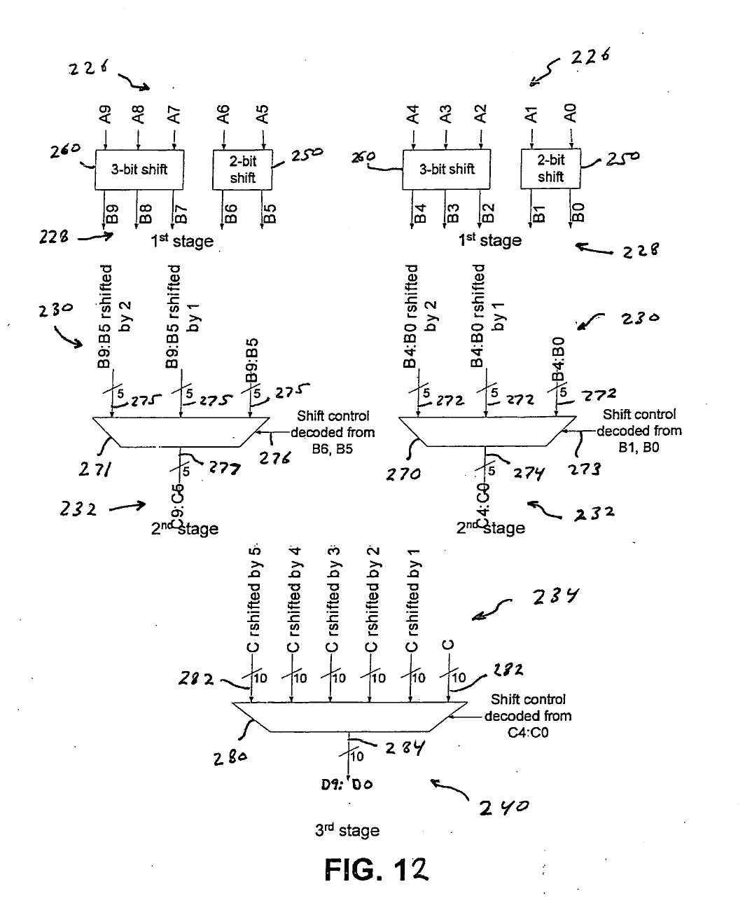

FIG. 12 is a diagram illustrating the overall shifting process in each of the three stages according to one embodiment of the present invention. The 10-bits of the corresponding column of the partial products is labeled A9:A0 along the top of FIG. 12. These bits are arranged in two and three bit groups 226. Each 2-bit group is shifted by a 2-bit shift circuit 250, and each 3-bit group is shifted by a respective 3-bit shift circuit 260 to produce first stage outputs B9:B0 (modified first-level groups 228). The values of B9:B0 correspond to row 202 in FIG. 9.

First stage outputs B9:B0 are arranged in two 5-bit groups 230 having bits B9:B5 and B4:B0, which are provided as inputs to multiplexers 270 and 271. Multiplexer 270 has three 5-bit inputs 272, which are coupled to bits B4:B0 unshifted, bits B4:B0 shifted to the right by one bit, and bits B4:B0 shifted to the right by two bits, respectively. Select input 273 controls selection between inputs 272 has a function of shift control signals decoded from bits B1 and B0. The selected input 272 is coupled to output 274 to provide a second stage output C4:C0. The shift control inputs are decoded from B1 and B0 according to the following logic equations, for example:
no shift=B1
shift right by 1=!B1 & B0
Shift right by 2=!B0,
where:
“!” represents a logical inversion; and
“&” represents a logical AND function.

Similarly, multiplexer 271 includes three 5-bit data inputs 275, shift control inputs 276 and output 277. Data inputs 275 are coupled to B9:B5 unshifted, B9:B5 shifted to the right by 1 bit position, and B9:B5 shifted to the right by two bit positions, respectively. Switch control inputs 276 are decoded from bits B6 and B5 in a similar fashion as the decoding of bits B1 and B0 shown above. Multiplexer output 277 provides second stage outputs C9:C5.

Second stage outputs C9:C0 correspond to groups 232 of row 203 shown in FIG. 9. These bits are provided to inputs 282 of multiplexer 280. Inputs 282 receive bits C9:C0 unshifted, shifted to the right by one bit, shifted to the right by two bits, shifted to the right by 3 bits, shifted to the right by 4 bits, and shifted to the right by 5 bits, respectively. Shift control inputs 283 are decoded from C4:C0 according to the following equations, for example:
no shift=C4
shift right by 1=!C4 & C3
shift right by 2=!C3 & C2
shift right by 3=!C2 & C1
shift right by 4=!C1 & C0
shift right by 5=!C0

Output 284 provides 10 bits, D9:D0 having all binary 1's shifted to the right, similar to row 204 in FIG. 9.

As discussed with respect to FIG. 9, the resulting 10-bit word D9:D0 is then encoded to form a binary word representing the number of 1's in D9:D0. Table 2 shows the encoding of D9:D0 into binary words, which form the modified partial products 110 shown in FIG. 7.

TABLE 2

| | | ENCODED |
|---|---|---|
| BITS | | BINARY |
| 9876543210 | ENCODING | WORD |
| 0000000000 | ZERO = !D0 | 0000 |
| 0000000001 | ONE = !D1&D0 | 0001 |
| 0000000011 | TWO = !D2&D1 | 0010 |
| 0000000111 | THREE = !D3&D2 | 0011 |
| 0000001111 | FOUR = !D4&D3 | 0100 |
| 0000011111 | FIVE = !D5&D4 | 0101 |
| 0000111111 | SIX = !D6&D5 | 0110 |
| 0001111111 | SEVEN = !D7&D6 | 0111 |
| 0011111111 | EIGHT = !D8&D7 | 1000 |
| 0111111111 | NINE = !D9&D8 | 1001 |
| 1111111111 | TEN = !D9 | 1010 |

Similar circuitry can be used in parallel with one another for counting the number of 1's in each bit column of partial products 100-102 to form modified partial products 110. Also, similar circuitry is used in each subsequent stage of the partial product reduction.

For example, similar circuitry is used to reduce the various columns in modified partial products 115-118 in FIG. 8. When reducing four partial products to three partial products, as shown in FIG. 8, this reduction is similar to the 10-to-4 reduction, except the third stage (multiplexer 280 in FIG. 12) can be eliminated. The circuits shown in FIGS. 10-12 can be modified to combine the particular number of bits in each column of the set of partial products being added. The groupings of bits in each stage can be performed in any convenient manner.

Reducing the three partial products 133-135 in FIG. 8 to two partial products can be done by using 3-bit shift blocks similar to 3-bit shift circuit 260 shown in FIG. 11, followed by an encoder similar to that in Table 2, but with less bits. Alternatively, a full adder can be used to add the bits.

A shift and recode multiplier is therefore provided in which N M-bit partial products are considered as M N-bit new partial products, which are recoded to binary numbers in parallel using shifters, where N and M can have any integer value. Each bit column of the original binary partial products is recoded to form one of the new partial products. This process is iterated until a pair of carry-sum-like values is generated.

In the above embodiment, with two M-bit binary numbers A and B, M/2 original partial products are generated using Radix-4 modified Booth recoding. Assuming the proper alignment of these partial products, all of the 1's in each bit column of the partial products is packed to one end or the other using a shift and recode circuit as described above. This eliminates the need to perform a conventional Wallace Tree to sum the partial products. There are a maximum of M/2 bits in each bit column. Thus, the original M/2 partial products are converted into 2Mlog₂(M/2)-bit partial products (rounded up to the nearest integer). However, each of these 2M partial products has only a maximum of ((log₂(M/2))−1) bits in each bit column. Using similar and shift and recode circuits, the number of bits per bit column can be reduced until each column has two bits. Thus, the circuit sums the original M/2 partial products to a carry-some pair as in a conventional multiplier.

As mentioned above, the circuit can be modified to accommodate a multiplier-accumulate (MAC) operation. For an MAC operation, an accumulation result is kept in the format of a carry-sum pair. This pair of binary numbers is fed back to the multiplier as if they were part of the original M/2 partial products, similar to rows 101 and 102 shown in FIG. 7. Using this mechanism, the multiplier result will be the multiplication of A and B plus the accumulator values. This mechanism incurs minimal cost to perform an MAC operation, and a final binary addition is carried out to sum the carry-sum pair at the next stage. Therefore, the throughput is a single cycle MAC operation.

With the above-embodiments, partial products can be added together faster while using less hardware. Existing methods combine partial products using 3-to-2 full bit-adders. The above embodiments allow more adder reduction options, such as 3-to-2, 7-to-3, 15-to-4, 31-to-5, etc., and thus can add many partial products together more quickly. The difference becomes more pronounced as the lengths of the multipliers and multiplicands increase and thus involve more partial products.

Although the present invention has been described with reference to preferred embodiments, workers skilled in the art will recognize that changes may be made in form and detail without departing from the spirit and scope of the invention. For example, bits can be shifted in any suitable manner. The logic states “1” and “0” are arbitrary and interchangeable symbols. The number of stages can be modified as desired or to accommodate any number of bits.

1. A method of adding a plurality of partial products, wherein each partial product has a plurality of bits having respective binary weights, wherein each bit can have a first or second logic state, the method comprising:
forming a first set of multiple-bit columns from bits of the plurality of partial products, wherein the bits in each column of the first set have the same binary weight; and
encoding each multiple-bit column in the first set into a respective modified partial product, which represents a number of bits in the column having the first logic state.

2. The method of claim 1 and further comprising:
forming a second set of multiple-bit columns from bits of the modified partial products, wherein the bits bit in each column of the second set have the same binary weight as one another; and
encoding each column in the second set into a respective further modified partial product, which represents a number of bits in the column having the first logic state.

3. The method of claim 1 and further comprising:
repeating the steps of forming and encoding to form successive sets of further modified partial products until the number of further modified partial products is reduced to a desired number.

4. The method of claim 3 and further comprising:
adding the desired number of further modified partial products to produce a product.

5. The method of claim 1 wherein encoding comprises:
for each multiple-bit column in the first set, forming a modified column word by packing all the bits in that column having the first logic state into a first contiguous set of bit positions in the modified column word; and
generating the respective modified partial product based on a pattern of the first and second logic states in the modified column word.

6. The method of claim 45 wherein:
forming a modified column word comprises packing all the bits in that column having the first logic state to one end of the modified column word; and
generating comprises generating the respective modified partial product based on the bit positions in the modified column word at which values of the bits in the modified column word transition between the first and second logic states.

7. The method of claim 5 wherein the modified column word comprises first and second opposite ends and the step of forming the modified column word comprises, for each multiple-bit column in the first set:
(a) grouping adjacent ones of the bits of the multiple-bit column into a present level of multiple-bit groups;
(b) for each group in the present level, packing any of the bits in that group having the first logic state toward a first end of that group, which corresponds in orientation to the first end of the modified column word, to form a respective modified present level group;
(c) grouping adjacent ones of the modified present level groups into respective higher level groups, with the higher level groups becoming the present level groups;
(d) repeating step (b) for the present level groups generated in step (c); and
(e) repeating steps (b) through (d) until there is only one present level group, which has the same number of bit positions as the modified column word and any of the bits in that group having the first logic state have been packed toward the first end of that group.

8. The method of claim 7 wherein step (b) comprises shifting the bits in that group having the first logic state to different bit positions in that group through a multiplexer.

9. A method of multiplying a multiplicand by a multiplier, the method comprising:
generating a plurality of partial products, wherein each partial product has a plurality of bits having respective binary weights, wherein each bit can have a first or second logic state;
forming a first set of multiple-bit columns from bits of the plurality of partial products, wherein the bits in each column of the first set have the same binary weight; and
encoding each multiple-bit column in the first set into a respective modified partial product, which represents a number of bits in the column having the first logic state.

10. The method of claim 9 and further comprising:
forming a second set of multiple-bit columns from bits of the modified partial products, wherein the bits bit in each column of the second set have the same binary weight as one another; and
encoding each column in the second set into a respective further modified partial product, which represents a number of bits in the column having the first logic state.

11. The method of claim 10 and further comprising:
repeating the steps of forming and encoding to form successive sets of further modified partial products until the number of further modified partial products is reduced to a desired number.

12. The method of claim 11 and further comprising:
adding the desired number of further modified partial products to produce a product.

13. The method of claim 9 wherein encoding comprises:
for each multiple-bit column in the first set, forming a modified column word by packing all the bits in that column having the first logic state into a first contiguous set of bit positions in the modified column word; and
generating the respective modified partial product based on a pattern of the first and second logic states in the modified column word.

14. The method of claim 13 wherein:
forming a modified column word comprises packing all the bits in that column having the first logic state to one end of the modified column word; and
generating comprises generating the respective modified partial product based on the bit positions in the modified column word at which values of the bits in the modified column word transition between the first and second logic states.

15. The method of claim 13 wherein the modified column word comprises first and second opposite ends and the step of forming the modified column word comprises, for each multiple-bit column in the first set:
(a) grouping one or more of the bits of the multiple-bit column that are adjacent to one another into a present level of multiple-bit groups;
(b) for each group in the present level, packing any of the bits in that group having the first logic state toward a first end of that group, which corresponds in orientation to the first end of the modified column word, to form a respective modified present level group;
(c) grouping one or more of the modified present level groups that are adjacent to one another into respective higher level groups, with the higher level groups becoming the present level groups;
(d) repeating step (b) for the present level groups generated in step (c); and
(e) repeating steps (b) through (d) until there is only one present level group, which has the same number of bit positions as the modified column word and any of the bits in that group having the first logic state have been packed toward the first end of that group.

16. The method of claim 15 wherein step (b) comprises shifting the bits in that group having the first logic state to different bit positions in that group through a multiplexer.

17. The method of claim 9 wherein generating a plurality of partial products comprises, for each partial product:
multiplexing the multiplicand multiplied by zero, the multiplicand multiplied by one, the multiplicand multiplied by minus one, the multiplicand multiplied by two, and the multiplicand multiplied by minus two to produce the respective partial product.

18. A multiplier circuit comprising:
a partial products generator comprising a multiplicand input, a multiplier input and a plurality of partial product outputs, wherein each output has a plurality of bits having respective binary weights and which can have a first or second logic state; and
adding means for forming a first set of multiple-bit columns from bits of the plurality of partial product outputs, wherein the bits in each column of the first set have the same binary weight, and encoding each column in the first set into a respective modified partial product, which represents a number of bits in the column having the first logic state.

19. The multiplier circuit of claim 18 wherein the partial products generator comprises a plurality of multiplexers, wherein each multiplexer multiplexes the multiplicand multiplied by zero, the multiplicand multiplied by one, the multiplicand multiplied by minus one, the multiplicand multiplied by two, and the multiplicand multiplied by minus two to a respective one of the partial product outputs.

20. The multiplier circuit of claim 18 wherein the adding means comprises:
means for forming a second set of multiple-bit columns from bits of the modified partial products, wherein the bits bit in each column of the second set have the same binary weight as one another; and
encoding means for encoding each column in the second set into a respective further modified partial product, which represents a number of bits in the column having the first logic state.

21. The multiplier circuit of claim 20 wherein the adder means further comprises:
means for repeating the steps of forming and encoding to form successive sets of further modified partial products until the number of further modified partial products is reduced to a desired number.

22. The multiplier circuit of claim 18 wherein the adding means comprises:
packing means for each multiple-bit column in the first set, for forming a modified column word by packing all the bits in that column having the first logic state into a first contiguous set of bit positions in the modified column word; and
generating means for generating the respective modified partial product based on a pattern of the first and second logic states in the modified column word.

23. The multiplier circuit of claim 22 wherein:
the packing means comprises means for packing all the bits in that column having the first logic state to one end of the modified column word; and
the generating means comprises means for generating the respective modified partial product based on the bit positions in the modified column word at which values of the bits in the modified column word transition between the first and second logic states.

24. The method of claim 1 and further comprising:
receiving an accumulation feedback value and using the accumulation feedback value as an additional member of the plurality of partial products in the steps of forming and encoding.

25. The method of claim 24 wherein the step of receiving an accumulation feedback value comprises receiving a plurality of feedback values and using the plurality of feedback values as additional members of the plurality of partial products in the steps of forming and encoding.

26. The method of claim 9 and further comprising:
receiving an accumulation feedback value and using the accumulation feedback value as an additional member of the plurality of partial products in the steps of forming and encoding.

27. The method of claim 26 wherein the step of receiving an accumulation feedback value comprises receiving a plurality of feedback values and using the plurality of feedback values as additional members of the plurality of partial products in the steps of forming and encoding.

28. The multiplier circuit of claim 18 and further comprising:
an accumulation feedback input, which feeds an accumulation value back to the adding means such that the adding means uses the accumulation value as an additional member of the plurality of partial products.

29. The multiplier of claim 28 wherein the accumulation feedback input comprises first and second accumulation feedback inputs for receiving first and second feedback values, respectively, which are used by the adder means as additional members of the plurality of partial products.
